(19) United States
(12) Patent Application Publication
(10) Pub. No.: US 2013/0202208 A1
(43) Pub. Date: Aug. 8, 2013

(54) INFORMATION PROCESSING DEVICE AND INFORMATION PROCESSING METHOD

(71) Applicant: CASIO COMPUTER CO., LTD., Tokyo (JP)

(72) Inventor: Hiroyasu IDE, Tokyo (JP)

(73) Assignee: CASIO COMPUTER CO., LTD., Tokyo (JP)

(21) Appl. No.: 13/752,896

(22) Filed: Jan. 29, 2013

(30) Foreign Application Priority Data
Feb. 6, 2012 (JP) 2012-023498

(51) Int. Cl. G06F 17/27; G06K 9/18

(52) U.S. Cl. CPC G06F 17/27; G06K 9/18
USPC 382/182; 704/9

(57) ABSTRACT

An information processing device comprises a word string acquirer which acquires a word string that is a target of analysis; a partial string extractor which extracts, using two words on either side of each space in the word string, a partial string containing one word but not the other, a partial string not containing the one word but containing the other, and a partial string containing both words from the word string; a division coefficient acquirer which acquires, for each partial string, division coefficients indicating degree of reliability in dividing the partial string by respective division patterns that divide the partial string into words; a probability coefficient acquirer which calculates a coefficient indicating probability that the word string is divided at the space based on the division coefficients; and an ouputter which determines division of the word string based on the coefficient, and divides and outputs the word string.

### CROSS-REFERENCE TO RELATED APPLICATION

This application claims the benefit of Japanese Patent Application No. 2012-023498 filed on Feb. 6, 2012, the entire disclosure of which is incorporated by reference herein.

### FIELD

This application relates generally to an information processing device and an information processing method.

### BACKGROUND

A display device has been heretofore known which divides by meaning a word string containing multiple words, and displays to a user the results of translating and/or analyzing the meaning of the divided words. With regard to this kind of display device, technology has been proposed for estimating between which words the word string to be analyzed should be divided.

For example, Patent Literature 1 (Unexamined Japanese Patent Application Kokai Publication No. H06-309310) proposes art for estimating how to divide a document using a syntax analyzer pre-programmed with grammar rules for the language to which the word string to be analyzed belongs.

In addition, Patent Literature 2 (Unexamined Japanese Patent Application Kokai Publication No. H10-254874) proposes art for partitioning character strings not separated by spaces into words.

With the art of Patent Literature 1, a syntax analyzer programmed with grammar rules for the language to which the text belongs is used for estimating between what words the text should be divided. Consequently, the estimation precision of the division method depends on the precision of the syntax analyzer. However, the problem arises that it is difficult to create a highly precise syntax analyzer, and the volume of calculations becomes large in order to execute highly precise syntax analysis.

In Patent Literature 2, art is disclosed for partitioning into words character strings not separated by spaces. However, no method is disclosed for determining between what words a character string is to be partitioned.

In considering the foregoing, it is an object of the present invention to provide an information processing device and an information processing method that can divide a word string to be analyzed, without using a syntax analyzer.

### SUMMARY

To achieve the above objective, an information processing device according to a first aspect of the present invention comprises:

a word string acquirer which acquires a word string that is a target of analysis;

a partial string extractor which extracts, using two words on either side of each space in the word string acquired by the word string acquirer, a partial string containing one word but not the other, a partial string not containing the one word but containing the other, and a partial string containing both words from the acquired word string;

a division coefficient acquirer which acquires, for each partial string extracted by the partial string extractor, division coefficients indicating degree of reliability in dividing the partial string by respective division patterns that divide the partial string into words;

a probability coefficient acquirer which calculates a coefficient indicating probability that the word string is divided at the space, based on the division coefficients acquired by the division coefficient acquirer; and

an ouputter which determines division of the word string that is the target of analysis based on the coefficient calculated by the probability coefficient acquirer, and divides and outputs the word string acquired by the word string acquirer.

With the present invention, it is possible to provide an information processing device and an information processing method that can divide a word string to be analyzed, without using a syntax analyzer.

### BRIEF DESCRIPTION OF THE DRAWINGS

A more complete understanding of this application can be obtained when the following detailed description is considered in conjunction with the following drawings, in which:

FIG. 1A is a block diagram showing a functional composition of an information processing device according to a first embodiment of the present invention;

FIG. 1B is a block diagram showing a hardware composition of the information processing device according to the first embodiment of the present invention;

FIGS. 2A to 2C are drawings for explaining a process executed by the information processing device according to the first embodiment, with FIG. 2A showing a photographic image, FIG. 2B showing results of partitioning a word string and FIG. 2C showing display data;

FIGS. 3A and 3B are drawings for explaining a process executed by the information processing device according to the first embodiment, with FIG. 3A showing a relationship between a character string and a tagged character string, and FIG. 3B showing a relationship among a word string, division flags, N-grams (Tri-grams) and division patterns;

FIG. 4 is a drawing showing a probability coefficient list (Bi-gram division pattern probability coefficient list) according to the first embodiment;

FIG. 5 is a block diagram showing a functional composition of an analyzer according to the first embodiment;

FIGS. 6A and 6B are drawings for explaining an example of the process executed by the information processing device according to the first embodiment, with FIG. 6A showing an example of a process for generating a division pattern from a word string, and FIG. 6B showing an example of a process for calculating a space probability coefficient;

FIG. 7 is a flowchart showing a menu display process executed by the information processing device according to the first embodiment;

FIG. 8 is a flowchart showing a menu partition process 1 executed by the information processing device according to the first embodiment;

FIG. 9 is a flowchart showing a space probability coefficient calculation process 1 executed by the information processing device according to the first embodiment;

FIG. 10 is a flowchart showing an N-gram probability coefficient acquisition process 1 executed by the information processing device according to the first embodiment;

FIG. 11 is a block diagram showing a functional composition of an information processing device according to a second embodiment of the present invention;

FIG. 12 is a block diagram showing a functional composition of an analyzer according to the second embodiment;

FIG. 13 is a drawing for explaining an example of a process for calculating a space probability coefficient executed by the information processing device according to the second embodiment;

FIG. 14 is a flowchart showing a menu partition process 2 executed by the information processing device according to the second embodiment;

FIG. 15 is a flowchart showing an N-gram probability coefficient acquisition process 2 executed by the information processing device according to the second embodiment;

FIG. 16 is a drawing showing an example of a Bi-gram probability coefficient list according to a variation of the second embodiment;

FIG. 17 is a block diagram showing a functional composition of an information processing device according to a third embodiment of the present invention;

FIG. 18 is a block diagram showing a functional composition of an analyzer according to the third embodiment;

FIG. 19 is a drawing for explaining a process executed by the information processing device according to the third embodiment; and

FIG. 20 is a flowchart showing a menu partition process 3 executed by the information processing device according to the third embodiment.

### DETAILED DESCRIPTION

Hereinafter, an information processing device according to embodiments to embody the present invention will be described with reference to the drawings. Identical or corresponding portions have the same numbers in drawings.

### First Embodiment

An information processing device 1 according to the first embodiment comprises: i) a photography function for photographing a paper and/or the like on which is written a character string (for example, a restaurant menu, a list of meals and/or the like) belonging to a specific category that is an analysis target; ii) a function for identifying and extracting a character string that is an analysis target from the photographed image; iii) a function for analyzing the extracted character string and converting such into a word string; iv) a function for outputting a coefficient indicating the probability that the menu can be divided at a specified part (between words) of the character string; v) a function for dividing the word string based on the division probability; vi) a function for converting the divided word string into display data, respectively; and viii) a function for displaying display data; and/or the like.

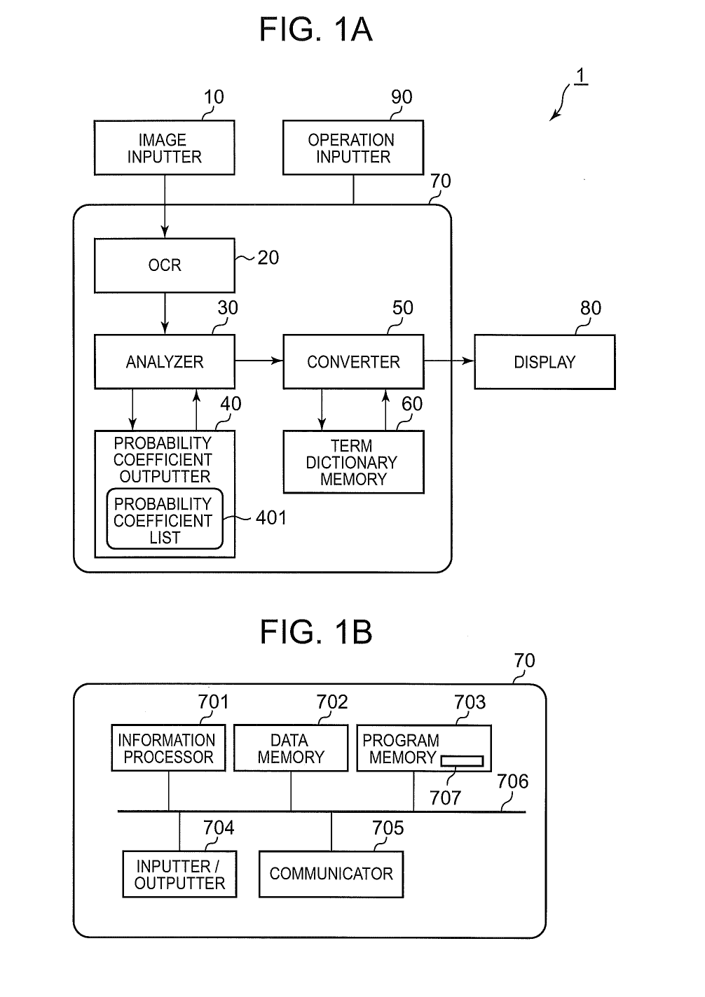

As shown in FIG. 1A, the information processing device 1 comprises an image inputter 10; an information processor 70 including an OCR (Optical Character Reader) 20, an analyzer 30, a probability coefficient outputter 40, a converter 50 and a term dictionary memory 60; a display 80; and an operation inputter 90.

The image inputter 10 is composed of a camera and an image processor, and through this physical composition acquires a photographic image of the menu. The image inputter 10 conveys the acquired image to the OCR 20.

As shown in FIG. 1B, The information processor 70 is physically composed of an information processor 701, a data memory 702, a program memory 703, an inputter/outputter 704, a communicator 705 and an internal bus 706.

The information processor 701 is composed of a CPU (Central Processing Unit), a DSP (Digital Signal Processor) and/or the like, and executes a below-described process according to the information processing device 1 in accordance with a control program 707 stored in the program memory 703.

The data memory 702 is composed of RAM (Random-Access Memory) and/or the like, and is used as a work space by the information processor 701.

The program memory 703 is composed of non-volatile memory such as flash memory, a hard disk and/or the like, and stores the control program 707 that controls actions of the information processor 701 and data for executing a process indicated below.

The communicator 705 is composed of a LAN (Local Area Network) device, a modem and/or the like, and sends process results from the information processor 701 to external equipment connected via LAN circuits or communication circuits. In addition, the communicator 705 receives information from external equipment and conveys such to the information processor 701.

The information processor 701, the data memory 702, the program memory 703, the inputter/outputter 704 and the communicator 705 are connected by the internal bus 706, enabling sending of information.

The inputter/outputter 704 is an I/O device that controls inputting and outputting information among the image inputter 10, the display 80, the operation inputter 90, external devices and/or the like connected to the information processor 70 by a USB (Universal Serial Bus) or serial port.

Through the above-described physical composition, the information processor 70 functions as the OCR 20, the analyzer 30, the probability coefficient outputter 40, the converter 50 and the term dictionary memory 60.

The OCR 20 recognizes characters in the image conveyed from the image inputter 10, and for example acquires character strings (food dish names and/or the like) recorded on a restaurant menu. The OCR 20 conveys the acquired character strings to the analyzer 30. The explanation below uses analysis of a restaurant menu as an example.

The analyzer 30 partitions the character string conveyed from the OCR 20 into words and converts such into a word string W. The analyzer 30 extracts a partial string (N-gram) containing at least one word comprising a space between words, for a space (a noteworthy space) between words comprising the word string W. Furthermore, the N-gram and information designating division patterns corresponding to cases when the word string can be divided by the space of the N-gram and cases when such cannot be divided are conveyed to the probability coefficient outputter 40. The N-gram, division patterns and division probability coefficients are described below.

The analyzer 30 receives coefficients (division probability coefficients, division pattern probability coefficients) indicating the degree of reliability that the N-gram can be divided with that division pattern, output by the probability coefficient outputter 40. The analyzer 30 analyzes the word string and extracts partial strings using the division probability coefficients received from the probability coefficient outputter 40, and outputs the partial strings (partitioned word string W) to the converter 50.

The probability coefficient outputter 40 is conveyed n words (an N-gram) from the analyzer 30 and information indicating division patterns for division probability coefficients which are necessary for the N-gram. The probability coefficient outputter 40 stores a probability coefficient list 401. Upon being provided with the N-gram and the information indicating division patterns from the analyzer 30, the probability coefficient outputter 40 references the probability coefficient list 401 with the division patterns as an argument, acquires division probability coefficients and conveys such to the analyzer 30.

The specific process executed by the probability coefficient outputter 40 is described below.

The converter 50 converts the partitioned word string W conveyed from the analyzer 30 into display data by referencing the term dictionary memory 60 for each partial string.

The converter 50 conveys words or word strings respectively contained in the partial strings to the term dictionary memory 60 and acquires analysis data for the words from the term dictionary memory 60. The converter 50 generates display data by lining up the words of the original menu and analysis data for the words, for each partial string.

The converter 50 conveys the generated display data to the display 80.

The term dictionary memory 60 stores a term dictionary in which the words or word strings contained in the menu that are instructor data, and data for explaining the words, are recorded associated with each other.

When a word or word string is conveyed from the converter 50 and the word or word string has been recorded, the term dictionary memory 60 conveys to the converter 50 analysis data recorded in the term dictionary associated with the word or word string. In addition, when the word or word string is not recorded, empty data indicating the fact is sent.

The display 80 is composed of a liquid crystal display and/or the like, and displays information conveyed from the converter 50.

The operation inputter 90 is composed of an operation receiving device for receiving operations from a user, such as a touch panel, keyboard, button, pointing device and/or the like, and a conveyer for conveying information about operations received by the operation receiving device to the information processor 70, and with this physical composition conveys operations from the user to the information processor 70.

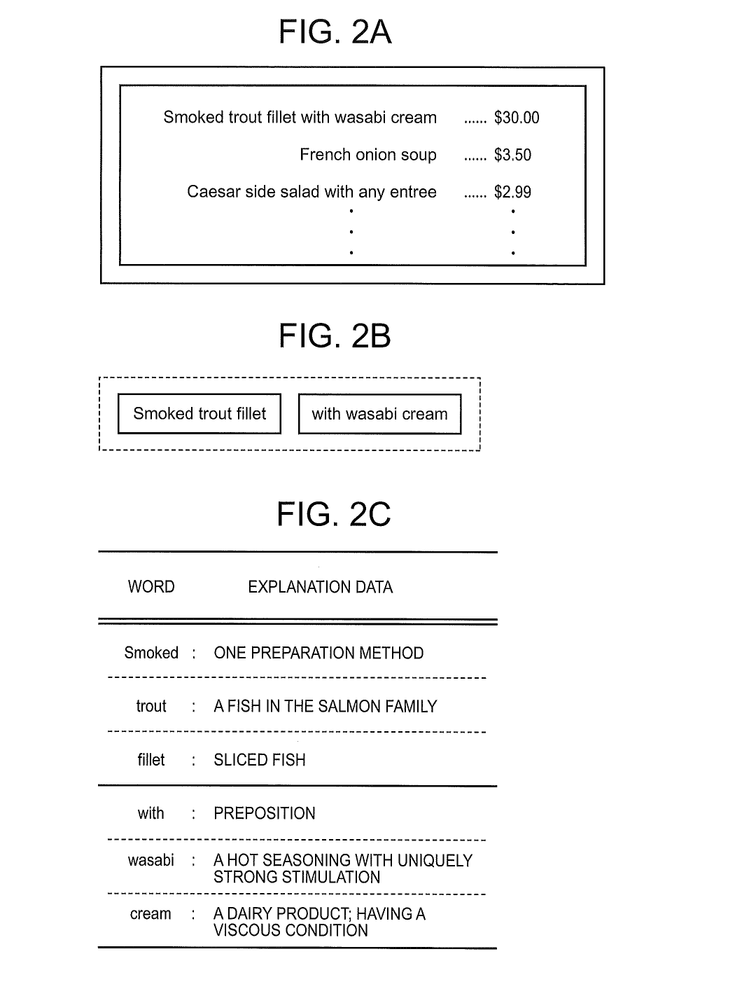

A relationship among the image of a menu photographed by the image processing device 1, the partitioned word string and the display data will now be explained with reference to FIGS. 2A to 2C.

When the user photographs a restaurant menu using the image inputter 10, the information processing device 1 acquires an image such as the one shown in FIG. 2A.

Furthermore, the OCR 20 extracts a character string from the image, the analyzer 30 partitions the character string into word units, and the result is conveyed to the converter 50 as a partitioned word string (partial string) such as shown in FIG. 2B. Furthermore, this is converted into display data with an appended explanation for each partial string, as shown in FIG. 2C, and displayed.

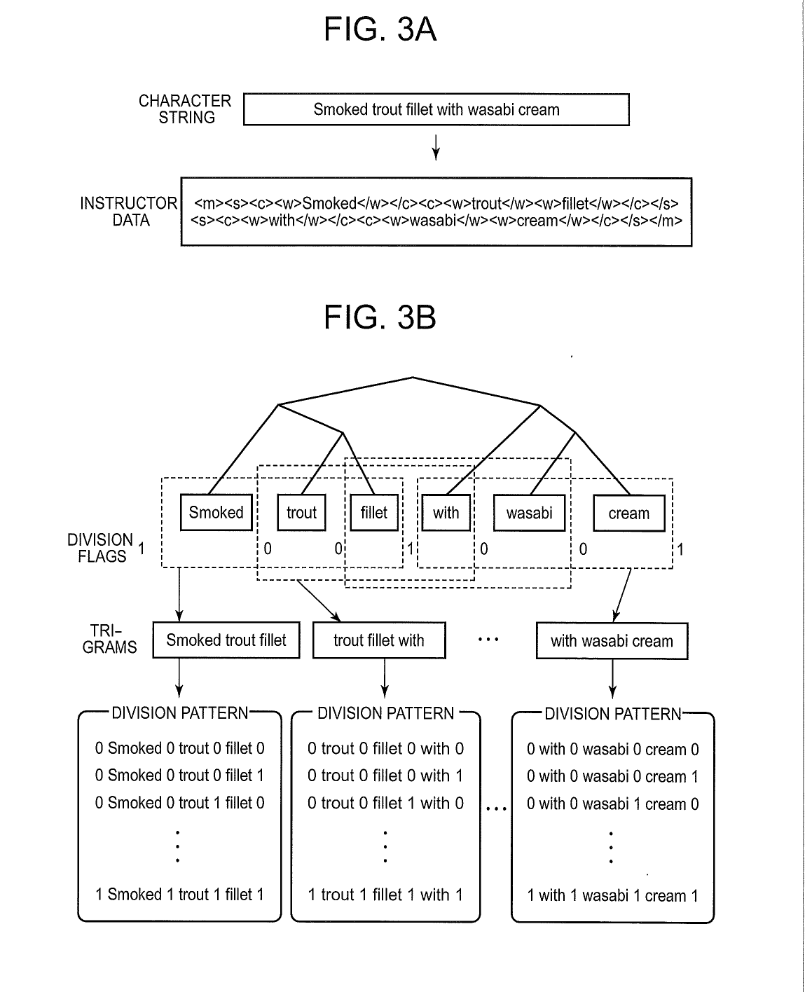

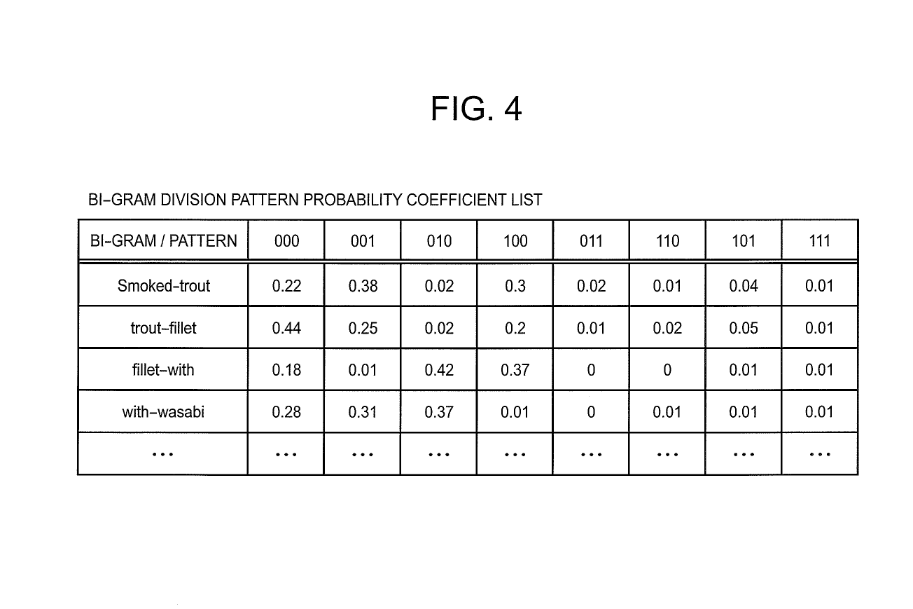

Next, the character string (menu) that is the analysis target in this embodiment, a tagged character string that is instructor data, the probability coefficient list 401, the N-grams, the division flags and the division patterns are explained with reference to FIGS. 3A, 3B and 4. The character string that is to be analyzed in this embodiment is a character string showing a menu of food dishes, such as that shown in FIG. 3A. Tags are appended to the menu item “smoked trout fillet with wasabi cream,” and data that is partitioned for each word or each cluster is the tagged character string, that is to say the instructor data. In the example in FIG. 3A, the instructor data is “<m><s><c><w>Smoked</w></c><c><w>trout</w><w>fillet</w></c></s><s><c><w>with</w></c><c><w>wasabi</w><w>cream</w></c></s></m>”. The instructor data is data that a person or syntax analyzer created by collecting and tagging character strings belonging to specific categories of specific words. The types and categories of words are not limited by the present invention and may be arbitrary.

In the instructor data of FIG. 3A, the character string is partitioned by the tags <w> and </w> into the six words of “Smoked”, “trout”, “fillet”, “with”, “wasabi” and “cream”. In addition, these are partitioned by the tags <c> and </c> into the four fragments of “Smoked”, “trout fillet”, “with” and “wasabi cream”. Furthermore, these are partitioned by the tags <s> and </s> into the two fragments of “Smoked trout fillet” and “with wasabi cream”. The tags <m> and </m> are tags for dividing the recognized character string by dish.

The character string indicated by this instructor data is divided by the tags <w>, </w>, <c>, </c>, <s>, </s>, <m> and </m>, but the way of defining these tags is not limited to this. For example, it would be fine for the character string to be divided for each word or cluster of multiple words, and to be divided by a unique mark or a space.

A relationship among the recognized character string, the instructor data, the division flags, the N-grams and the division patterns is shown in FIG. 3B. A combination of N-grams with N consecutive words extracted, such as from the first word through the Nth word, or from the second word through the N+l^{st} word, in a word string contained in the instructor data is an N-gram string. The N-gram is respectively called a Tri-gram when N=3, a Bi-gram when N=2 and a Mono-gram when N=1.

For example, from the character string “Smoked trout fillet with wasabi cream”, one Tri-gram string composed of the four Tri-grams “Smoked trout fillet”, “trout fillet with”, “fillet with wasabi” and” with wasabi cream” is obtained. This character string is divided into a tree shape through a tag structure, as shown in FIG. 3B. Furthermore, at which words to divide this from a semantic standpoint is determined up to a specified height of the tree determined based on system design.

The tree structure shown in FIG. 3B branches at the position where the tags <s> and </s> are, at the position where the tags <c> and </c> are, and at the position where the tags <w> and </w> are. In the division flags, a 1 is set when the string can be divided and a 0 is set when the string cannot be divided. Between what words the division flags are set is arbitrary. For example, it would be fine to define the divisions flags as only at parts where the <s> and</s> flags are, and/or the like.

The division pattern is data in which whether or not a word string can be divided between each word in an N-gram is defined, lining up words and division flags. For example, in the three words (word X, word Y and word Z) comprising a Tri-gram, a division pattern indicating that a division cannot be made between any words, including before the word X and after the word Z, is “0 X 0 Y 0 Z 0”. A division pattern indicating divisions are possible between all words is “1 X 1 Y 1 Z 1”.

The coefficient m/M computed from the number (for example, M) of items of instructor data including a given N-gram, and the number (for example, m) of items of instructor data in which the word string is divided by the division pattern of the N-gram, is defined as a coefficient (division probability coefficient, or division pattern probability coefficient) indicating the degree of reliability of a part corresponding to the N-gram being divided by the division pattern in the instructor data. If tagged character strings that are instructor data are prepared without bias in sufficient numbers (the larger M is), the more it is possible to regard the division probability coefficient as a coefficient indicating the degree of reliability that the part corresponding to the N-gram is partitioned in a manner corresponding to the partition pattern by the menu as a whole containing the N-gram in that language.

The list storing the N-gram division patterns and division probability coefficients associated with each other is the probability coefficient list (division pattern probability coefficient list). FIG. 4 shows an example of a Bi-gram division pattern probability coefficient list that is a probability coefficient list for the case when n=2. For example, the fact that the numerical value 0.02 is recorded in the column of the pattern “010” and the row of “smoked-trout” shows that the division probability coefficient of the division pattern “0 smoked 1 trout 0” is 0.02. The probability coefficient outputter 40 records division pattern probability coefficient lists defined respectively for Mono-grams to N-grams (where n is a value determined by settings). When the division probability coefficient of an N-gram not recorded in the probability coefficient list 401 is sought by the analyzer 30, the probability coefficient outputter 40 outputs a division probability coefficient corresponding to the (n−1)-grams to monograms that are partial strings of that N-gram, as the probability coefficient of that N-gram. Words not recorded in the monogram division pattern probability coefficient list are unknown words, so when the division probability coefficient of an N-gram containing an unknown word is sought, the corresponding default value is returned.

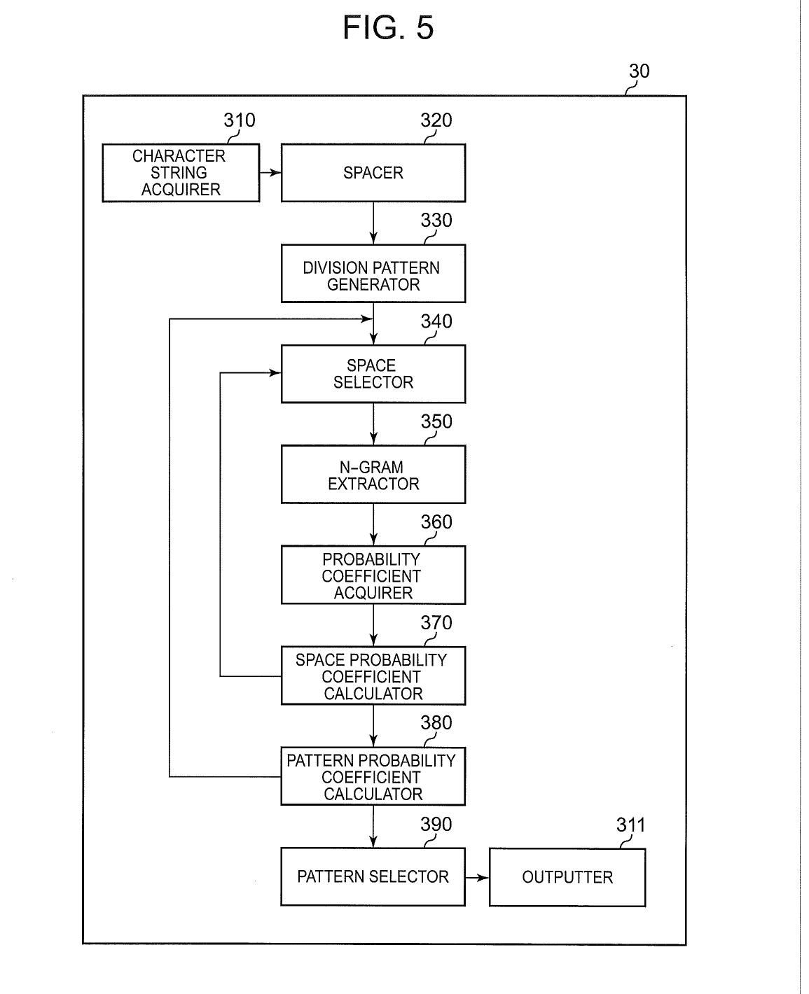

Next, the composition of the analyzer 30 is explained with reference to FIG. 5. The analyzer 30 is composed of a character string acquirer 310, a spacer 320, a division pattern generator 330, a space selector 340, an N-gram extractor 350, a probability coefficient acquirer 360, a space probability coefficient calculator 370, a pattern probability coefficient calculator 380, a pattern selector 390 and an outputter 311.

The character string acquirer 310 receives character strings extracted by the OCR 20 and conveys such to the spacer 320.

The spacer 320 executes a spacing process to partition the character string acquired by the character string acquirer 310 into word units. The spacer 320 may execute the above-described spacing process using an arbitrary, commonly known method for extracting words from character strings, but here the method exemplified by Patent Literature 2 is employed.

The spacer 320 recognizes spaces and executes the above-described spacing process when the menu that is the analysis target is in a language divided by spaces between each word, such as English, French and/or the like. The spacer 320 converts the character string of the menu into a word string W through the spacing process and conveys such to the division pattern generator 330.

When the word string W from the menu is conveyed from the spacer 320, the division pattern generator 330 generates division patterns corresponding to respective division methods for when the menu can be divided and cannot be divided at respective spaces in the word string W, for the respective division methods that can be defined. Establishing the division methods of the word string W that is the analysis target can be thought of as selecting one division pattern that can be defined for the N-gram that is the word string W, with the word string W as an N-gram. Hence, in this embodiment, all division methods (division patterns for the word string W) that can be defined for the word string W are defined, coefficients showing the reliability of the word string being divided by each division pattern are calculated, and one of the division patterns generated by the division pattern generator 330 is selected using those coefficients.

The division pattern generator 330 conveys the generated division patterns to the space selector 340.

The space selector 340 selects one of the unprocessed patterns from the conveyed division patterns as the noteworthy division pattern. Furthermore, the space closest to the front among the unprocessed spaces of the noteworthy division pattern is selected as the noteworthy space. Furthermore, the noteworthy division pattern, information indicating the selected space (noteworthy space) and a division flag for the space in the noteworthy division pattern are conveyed to the N-gram extractor 350.

When the noteworthy division pattern, information indicating the selected noteworthy space and the division flag of the space in the noteworthy division pattern are conveyed from the space selector 340, the N-gram extractor 350 extracts an N-gram containing either of words before or after the space. Furthermore, the same division pattern (corresponding division pattern) as the division flag of the space in the noteworthy division pattern for which the division flag corresponding to the noteworthy space was conveyed is generated, for the N-gram. Furthermore, the generated corresponding division patterns are conveyed to the probability coefficient acquirer 360. The value of n can be arbitrarily set, but in the explanation that follows, n=2.

When the corresponding division patterns are conveyed from the N-gram extractor 350, the probability coefficient acquirer 360 acquires the division probability coefficients for each corresponding division pattern. Specifically, the corresponding division patterns are conveyed to the probability coefficient outputter 40, and the division probability coefficients of the corresponding division patterns are received from the probability coefficient outputter 40. The probability coefficient acquirer 360 conveys the corresponding division patterns and the acquired division probability coefficients associated with each other to the space probability coefficient calculator 370.

When the corresponding division patterns and the division probability coefficients thereof are conveyed from the probability coefficient acquirer 360, the space probability coefficient calculator 370 calculates the probability that the space is divided by the division method of the noteworthy division pattern (space probability coefficient Piw). The process by which the space probability coefficient calculator 370 calculates the space probability coefficient Piw is explained in detailed below.

The division pattern generator 330, the space selector 340, the N-gram extractor 350, the probability coefficient acquirer 360 and the space probability coefficient calculator 370 calculate the space probability coefficients Piw for each space in the noteworthy division pattern by accomplishing the above-described process.

When the space probability coefficients Piw are calculated for all spaces in the noteworthy division pattern, the space probability coefficient calculator 370 conveys the calculated space probability coefficients Piw to the pattern probability coefficient calculator 380.

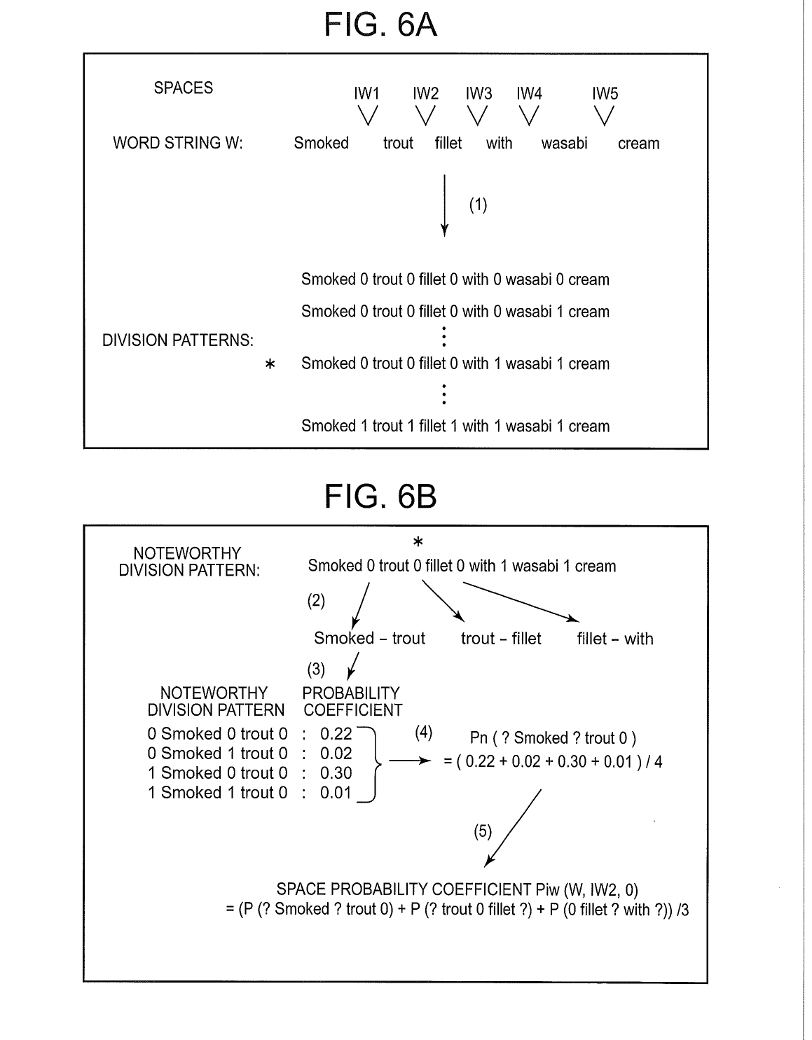

The processes executed by the division pattern generator 330, the space selector 340, the N-gram extractor 350, the probability coefficient acquirer 360 and the space probability coefficient calculator 370 will now be explained with reference to FIGS. 6A and 6B.

The word string W (Smoked-trout-fillet-with-wasabi-cream) is conveyed to the division pattern generator 330 from the spacer 320 (FIG. 6A, top). Spaces (spaces IW1 to IW5) can be defined between each word.

The division pattern generator 330 generates a division pattern for the case when the word string can be divided (division flag 1) and the case when this cannot be divided (division flag 0) by each of the spaces (spaces IW1 to IW5) in the word string W ((1) in FIG. 6A). When the number of spaces is Niw, 2 to the Niw power of division patterns can be defined.

The division pattern according the current process is the noteworthy division pattern, out of the generated division patterns. In FIG. 6A, the noteworthy division pattern (Smoked 0 trout 0 fillet 0 with 1 wasabi 1 cream) is indicated by the symbol *.

An example of the process for calculating the space probability coefficient for a space in the noteworthy division pattern (noteworthy space) is explained with reference to FIG. 6B. In the example in FIG. 6B, the space corresponding to the space IW2 is the noteworthy space (the space indicated by the symbol *). “Trout” and “fillet” can be extracted as words comprising the noteworthy space. Here, in this word string W, “Smoked-trout”, “trout-fillet” and “fillet-with” are extracted as N-grams (Bi-grams) containing “trout” or “fillet” ((2) in FIG. 6B).

Furthermore, the division patterns (corresponding division patterns) in which the division flag of the noteworthy space is common with the noteworthy division pattern are extracted, from the division patterns that can be defined for the Bi-gram, as the corresponding division patterns of the extracted Bi-gram ((3) in FIG. 6B).

For example, in the Bi-gram “Smoked-trout”, the division flag (noteworthy division flag) of the noteworthy space is 0, and the four patterns “0 Smoked 0 trout 0”, “0 Smoked 1 trout 0”, “1 Smoked 0 trout 0” and “1 Smoked 1 trout 0” can be extracted as the corresponding division patterns.

For the corresponding division patterns, the division probability coefficients are acquired from the probability coefficient acquirer 360, and from the acquired division probability coefficients, a noteworthy space N-gram probability coefficient Pn is calculated that is the probability that an instructor data containing the N-gram is divided by a division method corresponding to the noteworthy division flag (divisible or not divisible) at the space corresponding to the noteworthy space (see (4) in FIG. 6B). The noteworthy space N-gram probability coefficient Pn can be expressed as a function (Pn (? Smoked ? trout 0) in the example in FIG. 6B) converting to a division pattern in which division flags other than the noteworthy space of the noteworthy division pattern are a “?” indicating that either 0 or 1 is fine.

The noteworthy space N-gram probability coefficient Pn is a coefficient having the property that when at least one of the division probability coefficients of the corresponding division patterns becomes large and the other division probability coefficients are the same, the noteworthy space N-gram probability coefficient Pn also becomes large. In this embodiment, Pn is the arithmetic mean of the division probability coefficients of the corresponding division patterns. The method for calculating the noteworthy space N-gram probability coefficient Pn is not limited to this, for the product or the weighted sum of the division probability coefficients of the corresponding division patterns may also be used. In addition, a table in which the division probability coefficients of the corresponding division patterns and the noteworthy space N-gram probability coefficient Pn are associated with each other is stored in the recorded data memory 702, and the noteworthy space N-gram probability coefficient Pn may be calculated by referencing this table.

Furthermore, for each of the N-grams extracted in (2) in FIG. 6B, when the noteworthy space N-gram probability coefficient Pn is calculated, space probability coefficient Piw is calculated using the calculated noteworthy space N-gram probability coefficient Pn. The space probability coefficient Piw is expressed as a function in which a first variable is the word string W, a second variable is a symbol indicating the noteworthy space and a third variable is the noteworthy division flag (Piw (W, IW2, 0) in the example in FIG. 6B).

The space probability coefficient Piw is a coefficient that becomes larger when at least one of the noteworthy space N-gram probability coefficients Pn becomes larger and the others are the same. In this embodiment, the noteworthy probability coefficient Piw is the arithmetic mean of the noteworthy space N-gram probability coefficients Pn. The method for calculating the space probability coefficient Piw is not limited to this, for the product or the weighted sum of each noteworthy space N-gram probability coefficient Pn may also be used. In addition, a table in which Pn and the space probability coefficient Piw are recorded associated with each other is stored in the data memory 702, and the space probability coefficient Piw may be calculated by referencing this table.

When space probability coefficients Piw have been conveyed from the space probability coefficient calculator 370 for all of the spaces in the noteworthy division pattern, the pattern probability coefficient calculator 380 calculates the probability coefficient P of the noteworthy division pattern from the conveyed space probability coefficients Piw.

The probability coefficient P of the noteworthy division pattern is the product of the space probability coefficients Piw.

The method of calculating the probability coefficient P of the noteworthy division pattern is not limited to this, for this may also be calculated by an arbitrary method such that the probability coefficient becomes larger when at least one of the space probability coefficients Piw becomes larger and the other space probability coefficients Piw are the same, for each of the space probability coefficients Piw.

For example, P may be calculated using the geometric mean of the space probability coefficients Piw, and a table in which the space probability coefficients Piw and the probability coefficient P are recorded associated with each other is stored in the data memory 702, and the probability coefficient P may be calculated by referencing this table.

The space selector 340, the N-gram extractor 350, the probability coefficient acquirer 360, the space probability coefficient calculator 370 and the pattern probability coefficient calculator 380 calculate the probability coefficient P for each division pattern generated by the division pattern generator 330, associate each division pattern and the probability coefficient P thereof, and convey such to the pattern selector 390.

When each division pattern and the probability coefficient P thereof are conveyed, the pattern selector 390 selects the division pattern having the largest probability coefficient P. Furthermore, the word string W is partitioned using the division method indicated by the selected division pattern, and the post-partition partial strings are conveyed to the outputter 311.

The outputter 311 conveys the conveyed partial strings to the converter 50.

Next, the process executed by the information processing device 1 will be explained with reference to flowcharts.

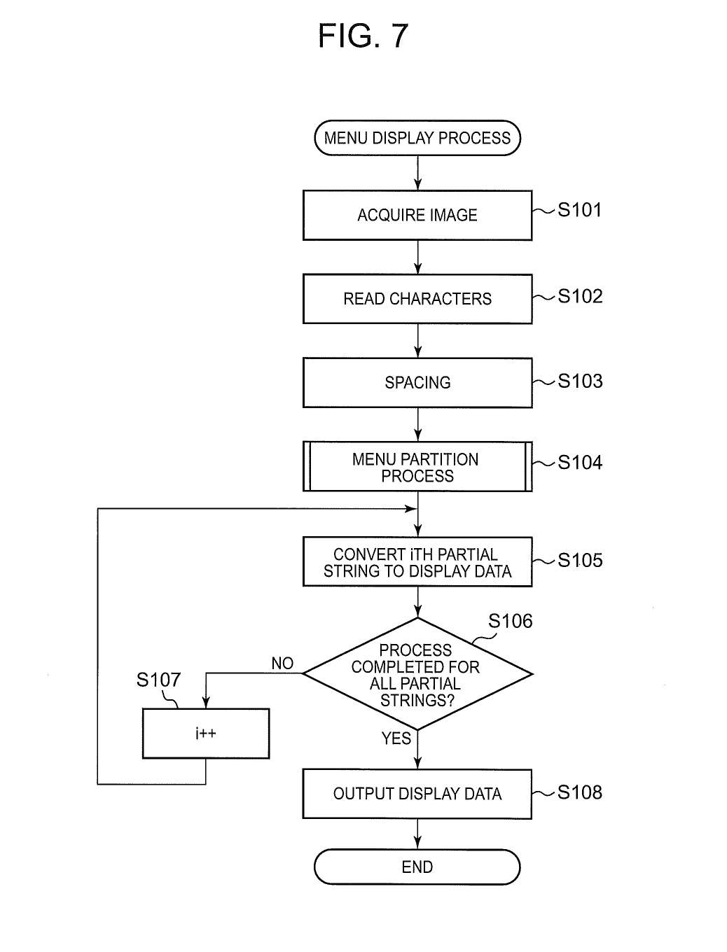

The information processing device 1 starts a menu display process shown in FIG. 7 when a user executes an operation to acquire an image of the menu using the image inputter 10.

In the menu display process, first an image in which the menu is imprinted is acquired using the image inputter 10 (step S101).

Furthermore, the OCR 20 recognizes characters and acquires a character string from the acquired image (step S102).

When the OCR 20 has acquired the character string and conveyed such to the analyzer 30, first the spacer 320 of the analyzer 30 executes a spacing process that partitions the character string into word units and converts the character string into the word string W (step S103).

Furthermore, the analyzer 30 estimates where in the word string the menu can be divided, and executes a process that partitions the menu (menu partition process 1) (step S104).

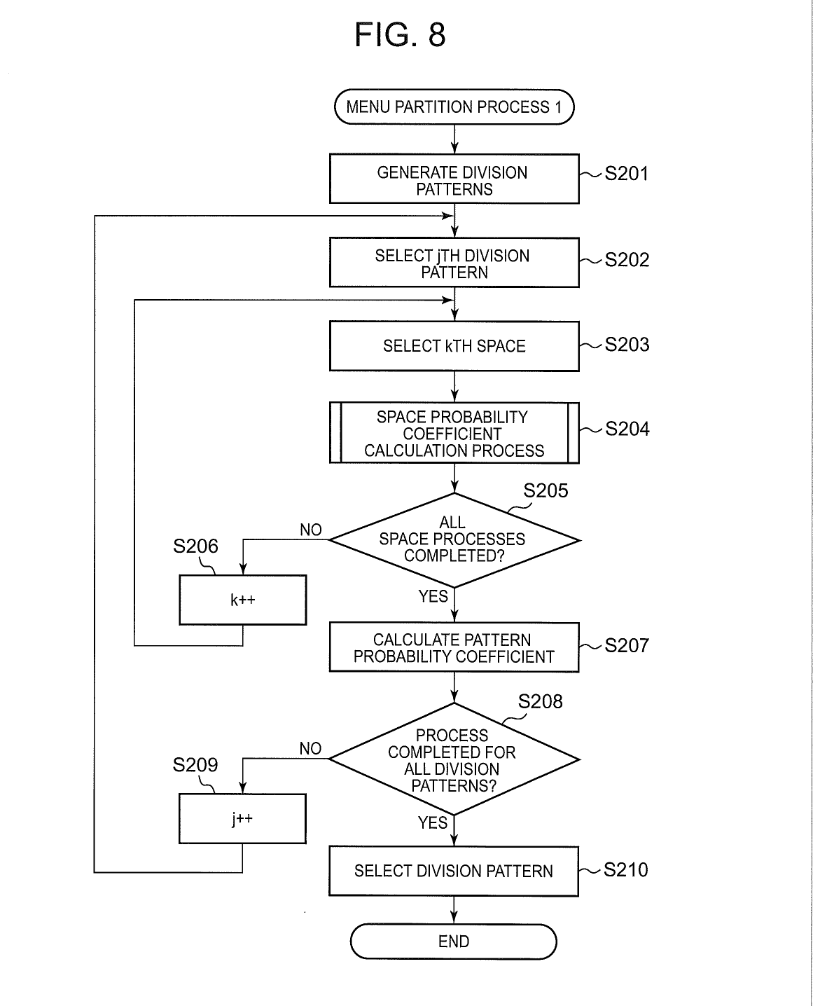

The menu partition process 1 executed in step S104 is explained with reference to FIG. 8.

In the menu partition process 1, first division patterns that can be defined for the word string W are generated (step S201, (1) in FIG. 6A).

Next, for the counter variable j, the jth division pattern of the generated division patterns is selected as the noteworthy division pattern (step S202).

Furthermore, for the counter variable k, the kth space of the noteworthy division pattern is selected as the noteworthy space (step S203).

When the noteworthy space is selected in step S203, the process of calculating the space probability coefficient Piw for the noteworthy space (the space probability coefficient calculation process, here the space probability coefficient calculation process 1) is executed (step S204).

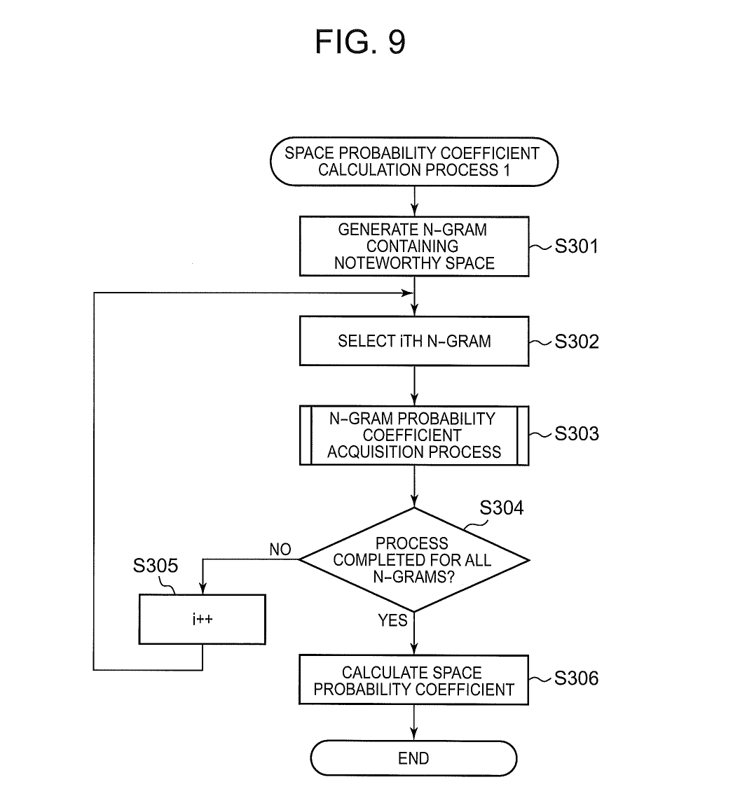

The space probability coefficient calculation process 1 executed in step S204 is explained with reference to FIG. 9. In the space probability calculation process 1, first an N-gram (here a Bi-gram) containing any of the words forming the noteworthy space is generated as exemplified in (2) of FIG. 6B (step S301).

Next, with 1 as the counter variable, the first Bi-gram is set as the noteworthy N-gram (step S302).

Furthermore, for the noteworthy N-gram, the process of calculating the noteworthy space N-gram probability coefficient Pn (N-gram probability coefficient acquisition process, here the N-gram probability coefficient acquisition process 1) is executed (step S303).

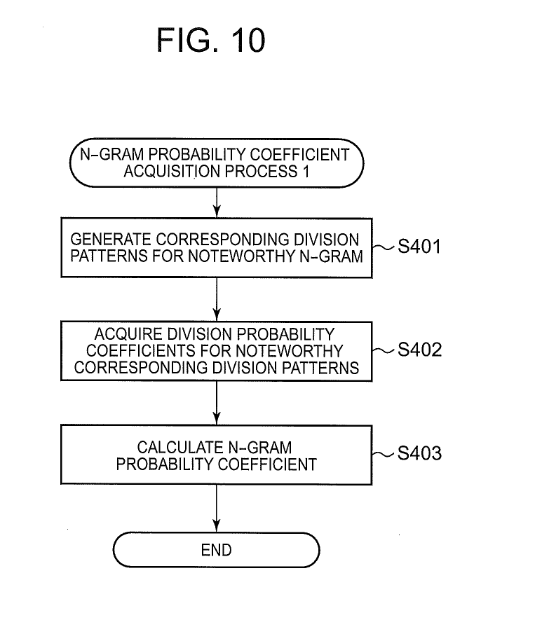

The N-gram probability coefficient acquisition process 1 executed in step S303 is explained with reference to FIG. 10.

In the N-gram probability coefficient acquisition process 1 first the N-gram extractor 350 generates the corresponding division pattern of the noteworthy N-gram as exemplified in (3) of FIG. 6B (step S401).

Furthermore, the probability coefficient acquirer 360 acquires the division probability coefficients of the various corresponding division patterns from the probability coefficient outputter 40 (step S402).

Next, the space probability coefficient calculator 370 calculates the noteworthy space N-gram probability coefficient Pn as exemplified by (4) in FIG. 6B by calculating the arithmetic mean of the division probability coefficients acquired in step S402 (step S403).

Then, the N-gram probability coefficient acquisition process 1 concludes.

Returning to FIG. 9, when the noteworthy space N-gram probability coefficient Pn is calculated, a determination is made as to whether or not the noteworthy space N-gram probability coefficient Pn has been calculated for all N-grams generated in step S301 (step S304).

When the noteworthy space N-gram probability coefficient Pn has not been calculated for all N-grams (step S304: No), the counter variable 1 is incremented (step S305) and the process is repeated from step S302 for the next N-gram.

On the other hand, when the noteworthy space N-gram probability coefficient Pn has been calculated for all N-grams (step S304: Yes), the space probability coefficient calculator 370 calculates the space probability coefficient Piw by calculating the arithmetic mean of the calculated noteworthy space N-gram probability coefficients Pn, as exemplified by (5) in FIG. 6B (step S306).

Then, the space probability coefficient calculation process 1 concludes.

Returning to FIG. 8, when the space probability coefficient calculation process (step S204) concludes and the space probability coefficient Piw of the noteworthy space is calculated, next a determination is made as to whether or not the space probability coefficients Piw have been calculated for all spaces in the noteworthy division pattern (step S205). When the space probability coefficients Piw have not been calculated for all spaces (step S205: No), the counter variable k is incremented (step S206) and the process is repeated from step S203 for the next space.

On the other hand, when the space probability coefficients Piw have been calculated for all spaces (step S205: Yes), it is determined that the space probability coefficients Piw have been calculated for all spaces in the current noteworthy division pattern. Hence, the pattern probability coefficient calculator 380 calculates the probability coefficient P of the noteworthy division pattern by multiplying the space probability coefficients Piw (step S207).

Next, a determination is made as to whether or not the probability coefficient P has been calculated for all division patterns generated in step S201 (step S208). When there is an unprocessed division pattern (step S208: No), the counter variable j is incremented (step S209) and the process is repeated from step S202 for the next division pattern.

On the other hand, when the probability coefficient P of all division patterns has been calculated (step S208: Yes), the pattern selector 390 selects the division pattern with the highest probability coefficient P (step S210). In step S210, the word string that is the analysis target is divided by the division method indicated by the selected division pattern, and each partition unit is partitioned into partial strings. With this, the menu partition process 1 concludes.

Returning to FIG. 7, when the word string acquired in step S103 is partitioned into partial strings with the menu partition process (step S104), with a counter variable of i, the converter 50 executes a process to generate display data for the ith partial string.

That is to say, analysis data for each word contained in the ith partial string is acquired from the term dictionary memory 60 and is converted to display data as shown in FIG. 2C (step S105).

Then, a determination is made as to whether or not the process of converting to display data has been concluded for all partial strings obtained in step S104 (step S106), and when this is not concluded (step S106: No), the counter variable i is incremented (step S107) and the process is repeated from step S105 for the next partial string.

On the other hand, when it is determined that all partial strings have been converted to display data (step S106: Yes), the display 80 displays the obtained display data in partial string units (step S108). With that, the menu display process 1 concludes.

As explained above, with the information processing device 1 according to this embodiment, it is possible to partition word strings expressing a menu based on instructor data, so it is possible to divide word strings even without preparing a syntax analysis program for each language.

In addition, for each space, because coefficients according to whether or not spaces can be divided are calculated from the division probability coefficients of multiple N-grams containing any of the words composing the space, even when the value of n is small the data volume referred to when determining the division method does not greatly decline, so there is little deterioration in the accuracy of the estimation of the division method. When the value of n becomes large, the instructor data volume necessary to calculate probability coefficients that can be relied on becomes enormous, but with this embodiment it is possible to make the value of n small. Consequently, it is possible to keep the necessary volume of instructor data to a minimum.

With this embodiment, the noteworthy space N-gram probability coefficients Pn are defined so as to be an increasing function at least in a prescribed defined range for each of the division probability coefficients of the corresponding division patterns. In addition, even the space probability coefficients Piw are defined so as to be an increasing function in at least a prescribed defined range for each of the corresponding noteworthy space N-gram probability coefficients Pn. Consequently, the information processing device 1 of this embodiment can estimate the division method for the word string that is the target of analysis by reflecting in the space probability coefficients the size of the reliability of dividing with the division method with instructor data containing the N-gram.

In addition, with the information processing device 1 according to this embodiment, the instructor data is generated from a designated category of character strings (here, menu items), so it is possible to calculate probability coefficients matching the categories more than in the case when probability coefficients of division patterns are calculated using instructor data for a broad range of categories (for example, the entire Japanese language).

Consequently, when the menu is partitioned using the information processing device 1, the accuracy of partitioning the menu is high.

In addition, when any of the space probability coefficients Piw becomes large, the probability coefficient P of the noteworthy division pattern also becomes large, so it is possible to select a division pattern having a large reliability that the learning data is divided by a division method for each space in the division pattern, and to divide the word string with the division method. Consequently, it is possible to divide the word string with a division method reflecting the division method for each word of the instructor data.

With the information processing device 1 according to this embodiment, it is possible to photograph the menu using the image inputter 10, to recognize character strings using the OCR 20 and to analyze and display the menu. Consequently, it is possible to take in the character strings of the menu without the user manually inputting the character strings of the menu expressly, and to display such with the addition of analysis data. Consequently, it is possible to display analysis data even in cases when manual input would be difficult, such as when the menu is written in a language the user does not know.

The pattern selector 390 of the information processing device 1 according to this embodiment selects one of the division patterns having the largest probability coefficient P and partitions and displays the word string with the division method. As a variation on this embodiment, a composition is also possible wherein the word string W is partitioned by multiple division methods for which the probability coefficient P of the division pattern satisfies prescribed conditions, and each of these partition results is converted and displayed. With this kind of composition, the analysis data is displayed with multiple division methods having high possibilities and are suggested to the user, so the likelihood that the correct division method can be suggested increases even in cases when the division method having the highest probability coefficient P is the wrong division method.

### Second Embodiment

Next, an information processing device 2 according to a second embodiment of the present invention is explained.

The information processing device 2 is characterized in that the word string is divided by a process in which division flags for each space are determined in order based on the space probability coefficients.

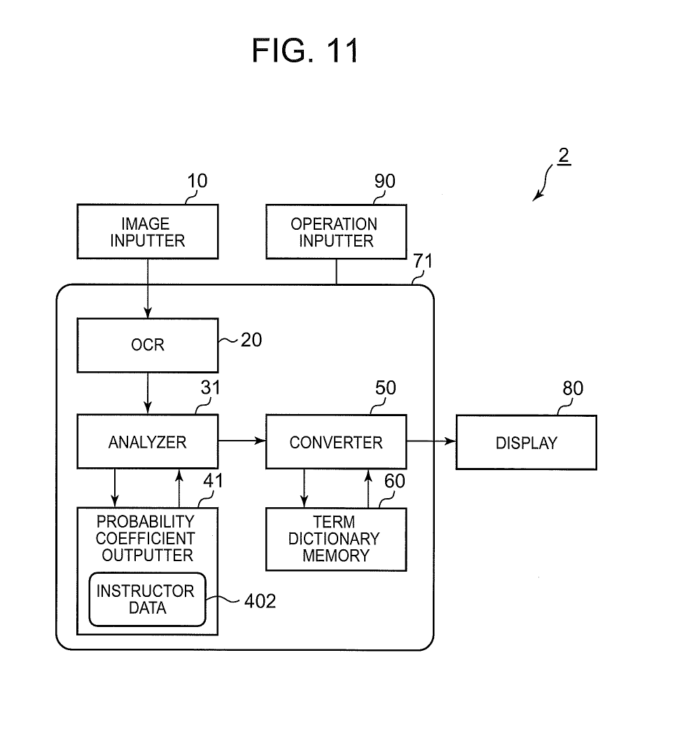

As shown in FIG. 11, the information processing device 2 comprises an image inputter 10; an information processor 71 including an OCR 20, an analyzer 31, a probability coefficient outputter 41, a converter 50 and a term dictionary memory 60; a display 80; and an operation inputter 90.

The functions and physical compositions of the image inputter 10, the OCR 20, the converter 50, the term dictionary memory 60 and the memory 80 of the information processing device 2 are the same as the corresponding compositions of the information processing device 1 according to the first embodiment. In addition, the physical composition of the information processor 71 is the same as the corresponding composition of the information processing device 1 according to the first embodiment, but the function of the analyzer 31 differs from that of the analyzer 30 in the first embodiment.

The analyzer 31 divides the word string conveyed from the OCR 20 and conveys such to the converter 50. In addition, the analyzer 31 conveys to the probability coefficient outputter 41 the N-gram, information designating spaces (spaces IWx) and information designating the division flags (y, y=0 or 1) in those spaces, and acquires the noteworthy space N-gram probability coefficients Pn (N-gram, IWx, y). The functional composition of the analyzer 31 and the contents of the process executed thereby for dividing the word string differ from those of the analyzer 30 according to the first embodiment.

The N-gram, information designating the spaces (spaces IWx), and the division flags (y, y−0 or 1) of those spaces are conveyed from the analyzer 31 to the probability coefficient outputter 41, which conveys the noteworthy space N-gram probability coefficients Pn (N-gram, IWx, y) to the analyzer 31.

The probability coefficient outputter 41 stores instructor data 402 and acquires the noteworthy space N-gram probability coefficients Pn (N-gram, IWx, y) by searching the instructor data 402.

The specific process executed by the probability coefficient outputter 41 is described below.

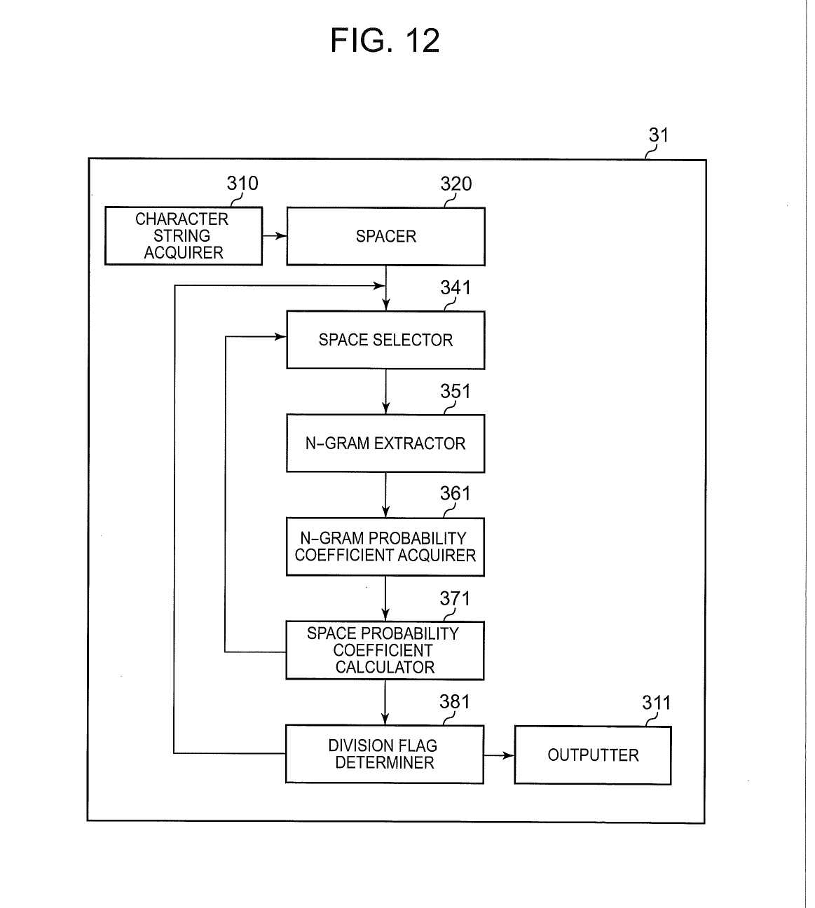

Next, the composition of the analyzer 31 is explained with reference to FIG. 12. As shown in FIG. 12, the analyzer 31 comprises a character string acquirer 310, a spacer 320, a space selector 341, an N-gram extractor 351, an N-gram probability coefficient acquirer 361, a space probability coefficient calculator 371, a division flag determiner 381 and an outputter 311.

The compositions of the character string acquirer 310 and the spacer 320 are the same as the corresponding compositions of the analyzer 30 of the first embodiment.

When a word string that is the target of analysis is conveyed from the spacer 320, the space selector 341 selects the spaces of the word string successively as the noteworthy spaces and conveys the word string and information indicating the noteworthy spaces to the N-gram extractor 351.

Upon receiving the N-grams and information indicating the noteworthy spaces from the space selector 341, the N-gram extractor 351 extracts N-grams containing any of the words before or after the noteworthy spaces. The extracted N-grams and information indicating the noteworthy spaces are then conveyed to the N-gram probability coefficient acquirer 361.

The N-gram probability coefficient acquirer 361 receives the N-grams and the information indicating the noteworthy spaces from the N-gram extractor 351. For each N-gram received, the N-gram probability coefficient acquirer 361 conveys to the probability coefficient outputter 41 the N-gram, information indicating the noteworthy spaces and information indicating the division flag 1. Furthermore, the N-gram probability coefficient acquirer 361 acquires the noteworthy space N-gram probability coefficients Pn (N-gram, IWx, 1) from the probability coefficient outputter 41.

The N-gram probability coefficient acquirer 361 conveys the acquired noteworthy space N-gram probability coefficients Pn to the space probability coefficient calculator 371.

Upon receiving the noteworthy space N-gram probability coefficients Pn (N-gram, IWx, 1) from the N-gram probability coefficient acquirer 361 for each N-gram extracted by the N-gram extractor 351, the space probability coefficient calculator 371 calculates the arithmetic mean of the respective noteworthy space N-gram probability coefficients Pn (N-gram, IWx, 1) and calculates the space probability coefficient Piw (W, IWx, 1). The space probability coefficient calculator 371 conveys the calculated space probability coefficient Piw to the division flag determiner 381.

When the space probability coefficient Piw is conveyed from the space probability coefficient calculator 371, the division flag determiner 381 compares the space probability coefficient Piw with the size of a threshold value stored in the data memory 702. When as a result of the comparison the space probability coefficient Piw is at least as great as the threshold value, the division flags of the noteworthy spaces are set as 1. On the other hand, when the space probability coefficient Piw is less than the threshold value, the division flags of the noteworthy spaces are set as 0.

The space selector 341, the N-gram extractor 351, the N-gram probability coefficient acquirer 361, the space probability coefficient calculator 371 and the division flag determiner 381 work together to determine the division flag for each space of the word string W, and divide the word string by a division method indicating the determined division flags, partitioning such into partial strings. The division flag determiner 381 outputs the partial strings to the outputter 311.

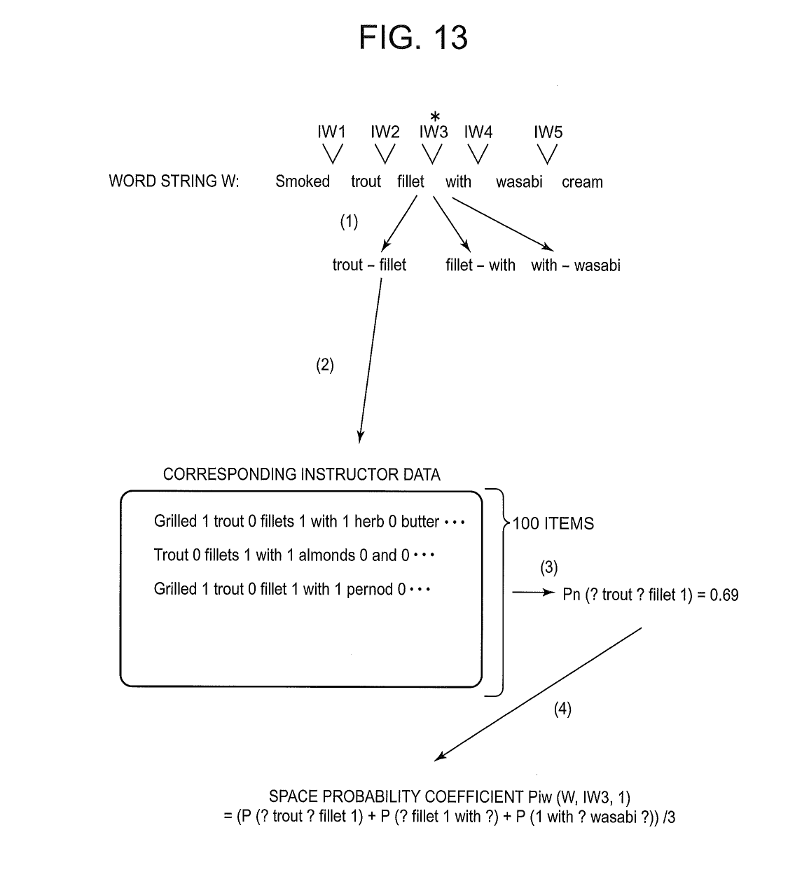

Next, an overview of the process executed by the analyzer 31 and the probability coefficient outputter 41 is explained with reference to FIG. 13.

For each space (spaces IW1 to IW5) in the word string W, the space selector 341 successively selects a noteworthy space. In the example in FIG. 13, the noteworthy space IW3 is indicated by the symbol *.

The N-gram extractor 351 extracts the N-grams (Bi-grams) containing the words “fillet” or “with” comprising the noteworthy space IW3, namely “trout-fillet”, “fillet-with” and “with-wasabi” ((1) in FIG. 13).

The probability coefficient outputter 41 extracts corresponding instructor data containing the extracted Bi-grams from among the instructor data 402 and calculates the number M of such. In the example in FIG. 13, 100 items of corresponding instructor data for “trout-fillet” are extracted.

Out of the extracted corresponding instructor data, the number m of items in which the division flag of the noteworthy space is 1 (69 in the example in FIG. 13) is calculated.

Furthermore, m/M is set as the noteworthy space N-gram probability coefficient Pn (N-gram, IW3, 1) ((3) in FIG. 13).

Furthermore, the noteworthy space N-gram probability coefficients Pn are similarly calculated for each extracted N-gram, and the space probability coefficient Piw is calculated by taking the arithmetic mean ((4) in FIG. 13).

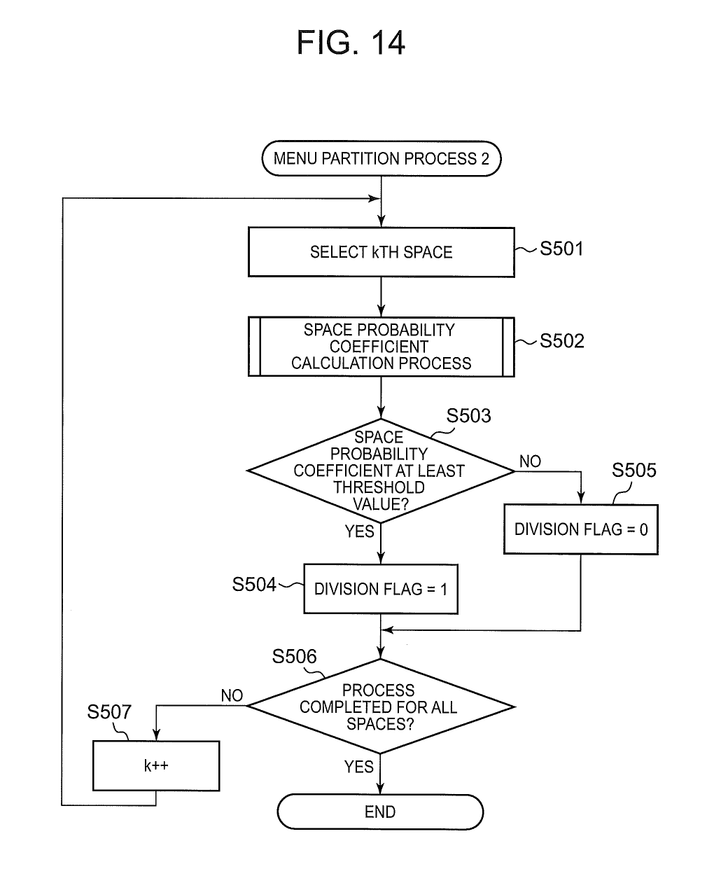

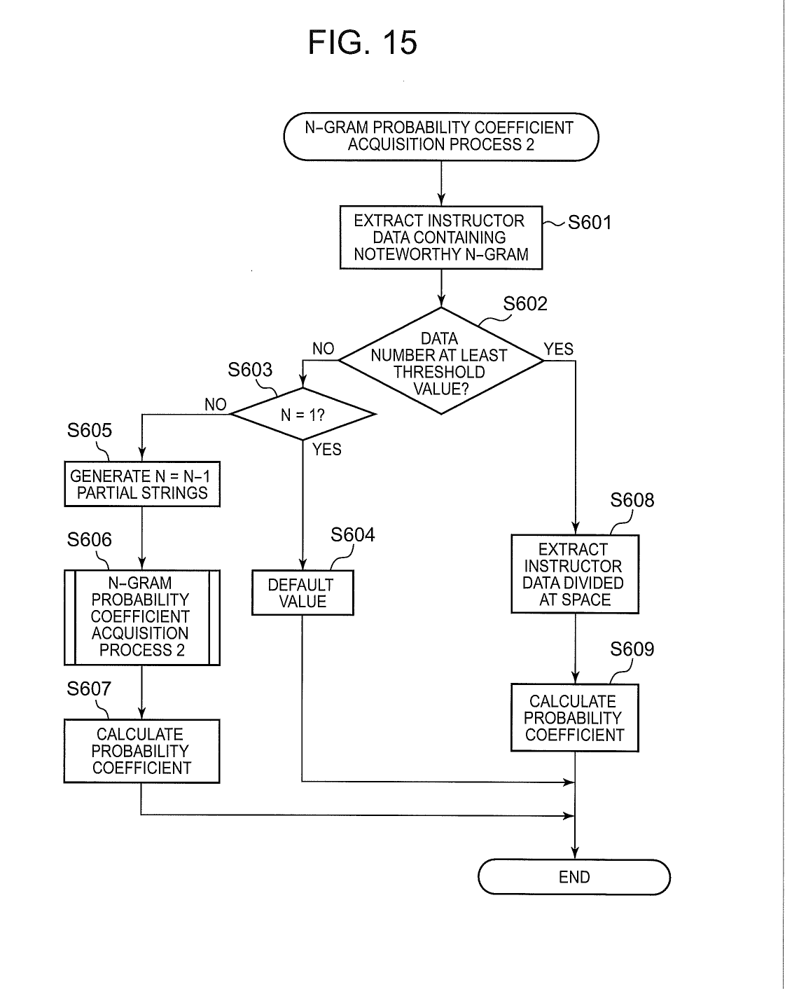

Next, the process executed by the information processing device 2 is explained with reference to flowcharts (FIGS. 14, 15).

When a user executes an operation to acquire an image of a menu using the image inputter 10, the information processor 71 of the information processing device 2 starts the menu display process shown in FIG. 7, the same as with the information processing device 1 according to the first embodiment.

The information processor 71 of the information processing device 2 executes the menu display process the same as the information processor 70 of the information processing device 1 according to the first embodiment with the exception that the menu partition process executed in step S104 is the menu partition process 2 shown in FIG. 14. The information processing device 2 generates and displays display data from the image of the menu through this menu display process.

The menu partition process 2 executed by the information processing device 2 in step S104 of the menu display process is explained with reference to FIG. 14. In the menu partition process 2, first for the counter variable k, the kth space of the word string W is selected as the noteworthy space (step S501).

Next, for the noteworthy space, the space probability coefficient calculation process 1 shown in FIG. 9 is executed and the space probability coefficient Piw (W, IWk, 1) of the noteworthy space is calculated (step S502).

The space probability coefficient calculation process executed in step S502 is executed the same as the space probability coefficient calculation process 1 according to the first embodiment with the exception that the N-gram probability coefficient acquisition process executed in step S303 is the N-gram probability coefficient acquisition process shown in FIG. 15.

The N-gram probability coefficient acquisition process 2 will be explained with reference to FIG. 15. In the N-gram probability coefficient acquisition process 2, first the instructor data containing the noteworthy N-gram selected in step S302 of the space probability calculation process 1 (FIG. 9) is extracted from the instructor data 402, as exemplified by (2) in FIG. 13 (step S601). In conjunction with this, the number m of data items extract at this time is acquired.

Next, a determination is made as to whether or not the number M of instructor data items extracted in step S602 is at least as great as a threshold value indicating the necessary number of data items, stored in the data memory 702 (step S602). This threshold value may be an arbitrary numerical value determined experimentally, but here is set to 0.5 so that division occurs when the probability of division is greater than the probability of not dividing.

When the result of the determination is that the number is at least as great as the threshold value (step S602: Yes), it can be determined that a sufficient number of instructor data items for calculating the noteworthy space N-gram probability coefficients Pn for the current N-gram can be gathered. Hence, instructor data divided by the noteworthy space is extracted from among the extracted instructor data and the number m of those items is acquired (step S608). Furthermore, m/M is calculated as the noteworthy space N-gram probability coefficient Pn (step S609), as exemplified by (3) in FIG. 13.

On the other hand, when the number M of instructor data items is smaller than the threshold value (step S602: No), it can be determined that a sufficient number of instructor data items for calculating the noteworthy space N-gram probability coefficients Pn cannot be gathered for the current N-gram, so the noteworthy space N-gram probability coefficients Pn are calculated from the noteworthy space N-gram probability coefficients Pn of the partial string (n=n−1) or a default value.

Specifically, first a determination is made as to whether or not the current n is 1 (step S603). Furthermore, when n=1 (step S603: Yes), the current noteworthy N-gram is a Mono-gram, so it can be determined that it is not possible to further extract partial strings. Hence, the monogram is considered an unknown word, and the default value defined for unknown words is set as the noteworthy space N-gram probability coefficient Pn of the noteworthy N-gram (step S604).

On the other hand, when n is not equal to 1 (step S603; No), partial strings are extracted from the current noteworthy N-gram and probability coefficients are acquired for those partial strings.

Specifically, two (n−1)-grams are extracted from the current noteworthy N-gram and new noteworthy N-grams (n=n−1) are set (step S605). Furthermore, for each of the new noteworthy N-grams that are partial strings, the N-gram probability coefficient acquisition process 2 is repeatedly executed to calculate the noteworthy space N-gram probability coefficients Pn of the partial strings (step S606). Furthermore, the arithmetic mean of the noteworthy space N-gram probability coefficients Pn of the two partial strings calculated is taken and this is set as the noteworthy space N-gram probability coefficient Pn of the noteworthy N-gram (step S607).

When the noteworthy space N-gram probability coefficients Pn of the noteworthy N-grams are calculated by any of steps S607, S604 and S609 as described above, the N-gram probability coefficient acquisition process 2 concludes.

Returning to FIG. 14, when the noteworthy space N-gram probability coefficients Pn are calculated by the N-gram probability coefficient acquisition process 2 and the space probability coefficient Piw (W, IWk, 1) is calculated by the space probability coefficient calculation process using the noteworthy space N-gram probability coefficients Pn calculated (step S502), and next the division flag determiner 381 determines whether or not the space probability coefficient Piw (W, IWk, 1) is at least as great as a prescribed threshold value stored in the data memory 702 (step S503).

When it is determined that the space probability coefficient Piw (W, IWk, 1) is at least as great as the prescribed threshold value (step S503: Yes), that space has a high probability of being divisible by the instructor data having the N-gram comprising the space and can be estimated as being where the word string W can be divided also, so the division flag determiner 381 sets the corresponding division flag to 1 (step S504).

On the other hand, when it is determined that the value is smaller than the prescribed threshold value (step S503: No), it can be estimated that the word string W cannot be divided at the space, so the division flag determiner 381 sets the corresponding division flag to 0 (step S505).

Next, a determination is made as to whether or not division flags have been set for all spaces in the word string W (step S506). When division flags have not been set for all spaces (step S506: no), the counter variable k is incremented (step S507) and the process from step S501 is repeated for the next space.

On the other hand, when the process has been completed for all spaces (step S506: Yes), it can be determined that the division flags have been set for all spaces so the menu partition process concludes.

As described above, the information processing device 2 of this embodiment successively sets division flags for all spaces. Consequently, it is possible to divide the word string W with a small calculation volume compared to when division probabilities are calculated for each corresponding division pattern when division is possible and when division is not possible at each space.

In the above explanation, the instructor data is stored by the probability coefficient outputter 41 but the instructor data may be stored on an external server or may be acquired as needed using a communicator 705.

Furthermore, the probability coefficient outputter 41 may store, in place of the instructor data, a list (N-gram probability coefficient list) storing the N-gram and noteworthy space N-gram probability coefficients Pn associated with each other, and may calculate the noteworthy space N-gram probability coefficients Pn by referencing this list.

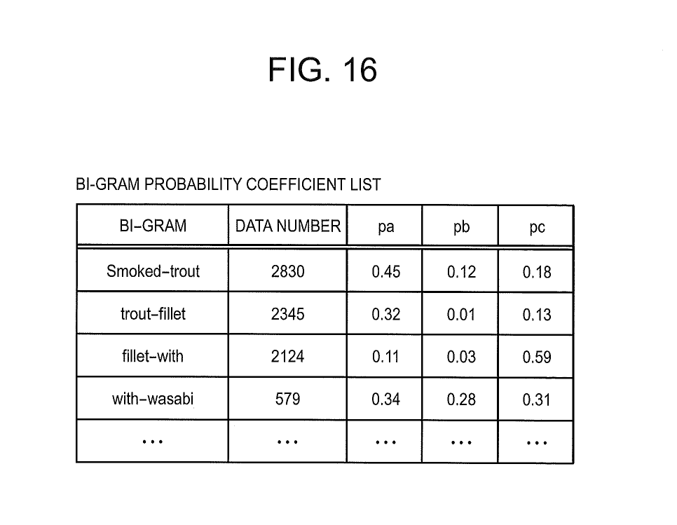

An example of this kind of N-gram probability coefficient list will be explained with reference to FIG. 16. In the example in FIG. 16, Bi-grams (N-grams where n=2), noteworthy space N-gram probability coefficients Pn corresponding to each space in the N-gram, and the number M of instructor data items that are the basis for calculating the probability coefficient are stored associated with each other.

For example, the fact that the numerical value 0.12 is recorded in the row of the Bi-gram “Smoked-trout” and the column “pb” in FIG. 16 indicates that 0.12 is the noteworthy space N-gram probability coefficient Pn (? Smoked 1 trout ?) when Smoked-trout is the noteworthy N-gram. In addition, the fact that the number of data items in the row is 2,830 indicates that the value of pb is a numerical value obtained from 2,830 items of instructor data.

### Third Embodiment

Next, an information processing device 3 according to a third embodiment of the present invention is explained.

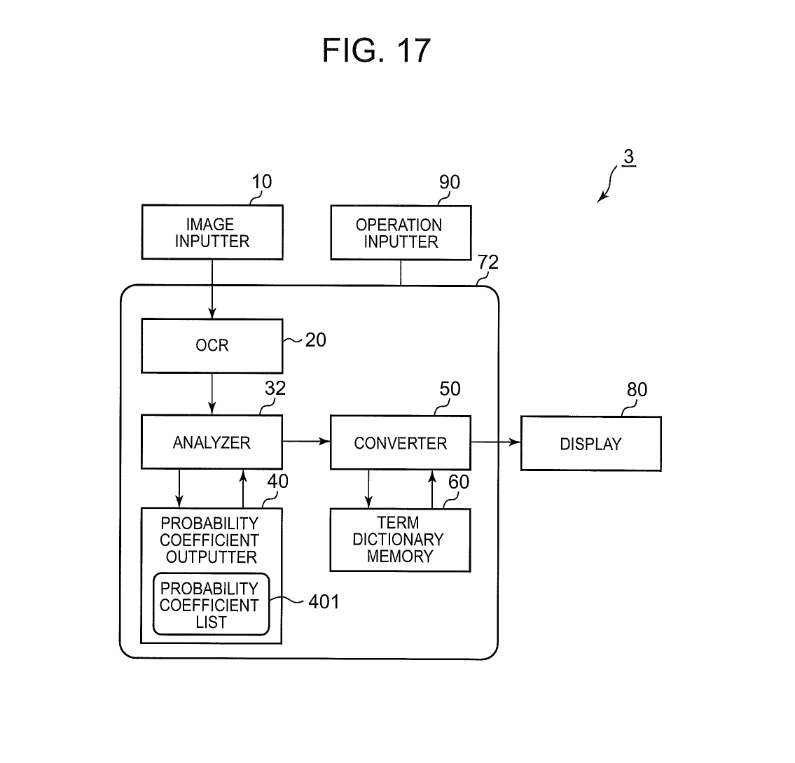

As shown in FIG. 17, the information processing and display device of this embodiment comprises an image inputter 10; an information processor 72 including an OCR (Optical Character Reader) 20, an analyzer 32, a probability coefficient outputter 40, a converter 50 and a term dictionary memory 60; a display 80; and an operation inputter 90. The information processing device 3 of this embodiment differs from the information processing devices of the first and second embodiments in the process executed by the analyzer 32 for determining the division flags of each space. The other components are the same as the components of the same name in the information processing device 1 of the first embodiment.

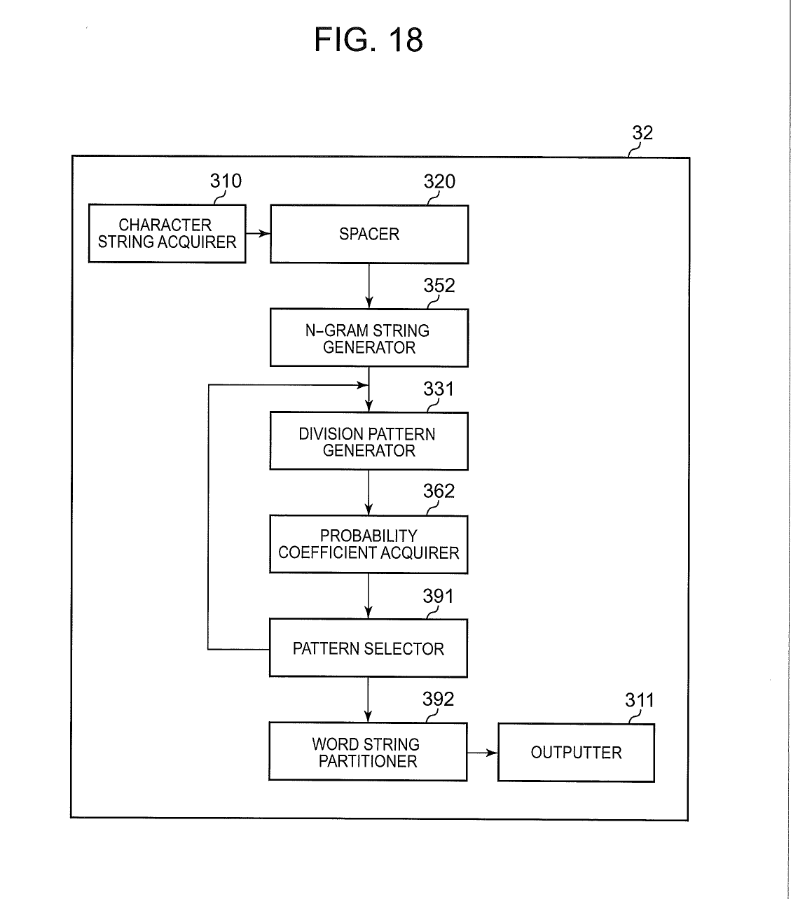

As shown in FIG. 18, the analyzer 32 of this embodiment comprises a character string acquirer 310, a spacer 320, an N-gram string generator 352, a division pattern generator 331, a probability coefficient acquirer 362, a pattern selector 391, a word string partitioner 392 and an outputter 311.

The character string acquirer 310 and the spacer 320 are the same as the components of the same name according to the first embodiment.

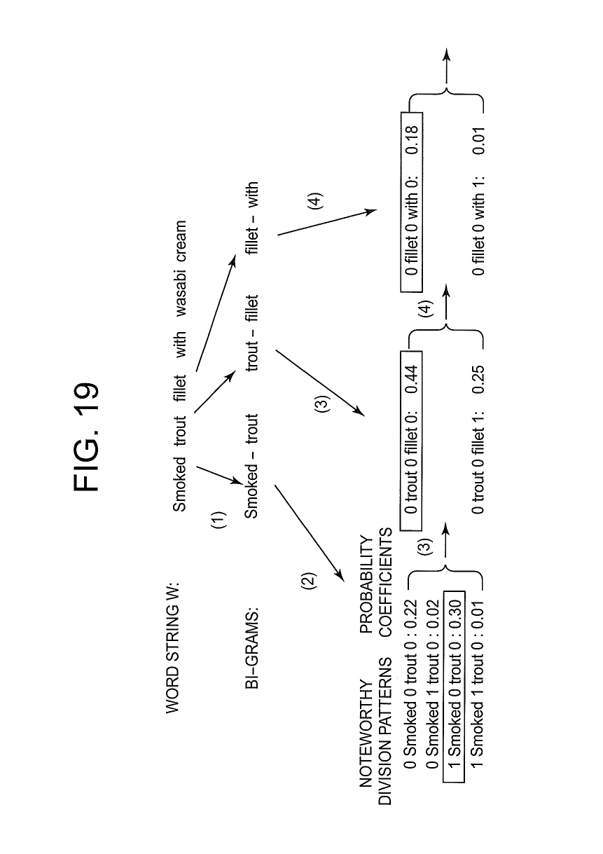

The N-gram string generator 352 extracts a string of N-grams (here, Bi-grams) from the word string W ((1) in FIG. 19). What are called N-gram strings here are collections of word strings containing n words, such as from the first word through the nth word, from the second word through the n+1^{st} word, and so forth, from the word string W.

Furthermore, the division pattern generator 331 generates the corresponding division pattern for each N-gram (Bi-gram) generated by the N-gram string generator 352. First, all division patterns that can be defined for the leading Bi-gram are created as the corresponding division patterns. On top of this, the probability coefficient acquirer 362 acquires the division probability coefficients of the corresponding division patterns from the probability coefficient outputter 40 ((2) in FIG. 19). Furthermore, the pattern selector 391 selects the division pattern having the highest division probability coefficient (here, “1 Smoked 0 trout 0”).

Furthermore, the analyzer 32 notices the adjacent Bi-grams, and the division pattern generator 331 generates division patterns (corresponding division patterns) having the same division flags for the corresponding spaces ((3) in FIG. 19). Here, for “1 Smoked 0 trout 0”, the corresponding division patterns are “0 trout 0 fillet 0” and “0 trout 0 fillet 1”. Furthermore, the pattern selector 391 selects the division pattern having the largest division probability coefficient from among the corresponding division patterns. Following this, the same selection is made for the next Bi-gram ((4) in FIG. 19). Through this, the division method (division flag) for each space is determined.

When the division pattern is selected for all N-grams, the word string partitioner 392 divides the word string W using the selected division method for the division pattern. Furthermore, the outputter 311 outputs the partial strings, which are the results of division.

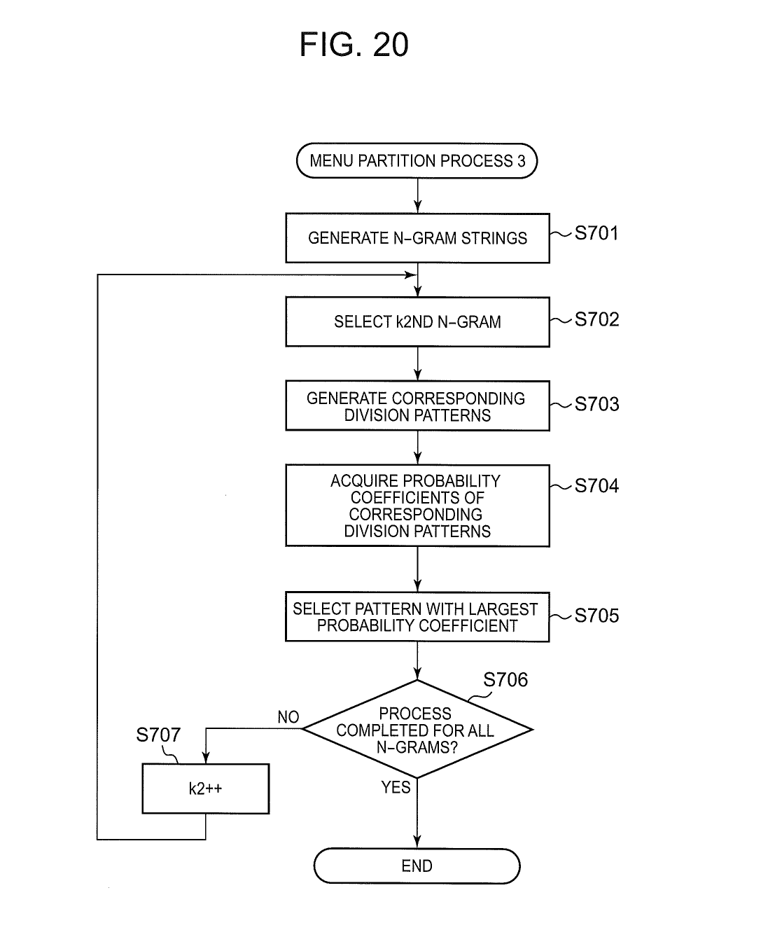

Next, the process executed in this embodiment is explained with reference to flowcharts. The information processing device 3 of this embodiment executes the menu display process shown in FIG. 7, the same as the first embodiment. However, in this embodiment the menu partition process executed in step S104 is the menu partition process 3 shown in FIG. 20.

The menu partition process 3 of this embodiment will be explained with reference to FIG. 20. In the menu partition process 3, the N-gram string generator 352 generates a string of N-grams from the word string W (step S701). Then, with k2 as the counter variable, the k2nd N-gram is selected as the noteworthy N-gram (step S702). The noteworthy N-gram transitions from the leading (or last) N-gram to the adjacent N-gram in order.

Next, the division pattern generator 331 generates the corresponding division patterns of the noteworthy N-gram (step S703). In the initial loop, all division patterns that can be defined for the noteworthy N-gram are generated. In the second and subsequent loops, two division patterns are generated from among the division patterns that can be defined for the noteworthy N-gram, namely the division pattern selected in the previous loop and the division pattern having the same division flags for common spaces.

Furthermore, the probability coefficient acquirer 362 acquires the division probability coefficients from the probability coefficient outputter 40 the same as in step S402 of FIG. 10 for the generated corresponding division patterns.

Next, the pattern selector 391 compares the division probability coefficients acquired in step S704 and selects the division pattern having the highest division probability coefficients out of the corresponding division patterns generated in step S703 (step S705).

When the pattern selector 391 selects a division pattern, next a determination is made as to whether or not a division pattern was selected for all N-grams (step S706).

When selection has not been made for all N-grams (step S706: No), the counter variable k2 is incremented (step S707) and the process from step S702 is repeated for the next N-gram (adjacent N-gram).

On the other hand, when selection has been made for all N-grams (step S706: Yes), the menu partition process concludes. Following this, the word string is partitioned using the division method selected by the word string partitioner 392, and the outputter 311 outputs the partition results to the converter 50.

As explained above, with the information processing device 3 of this embodiment, the division method for each space is determined with reference to division methods set to that point. Consequently, it is possible to estimate the division method with good accuracy.

(Variations)

Above, the embodiments of the present invention were explained, but the embodiments of the present invention are not limited thereto.

For example, in the above-described first through third embodiments, the word string W was extracted from an image photographed by the image inputter 10, but the word string W may be extracted from character strings the user inputs using a keyboard. In addition, character strings may be acquired through audio recognition from audio data.

In addition, in the above-described first through third embodiments, the converter created display data by appending to each word analysis text recorded in the term dictionary.

However, in the present invention, the method of creating display data using the partitioned word string is not limited to this. For example, the partitioned word string may be translated using an arbitrary translation device for each partial string, and the translation results may be made into display data. With this kind of information processing device, when the input menu is in Chinese, for example, even for a user who understands only Japanese and cannot input character strings in Chinese using a keyboard, it is possible to display a summary of the menu in Japanese by executing the operation of photographing the menu.

In addition, the database of the term dictionary and/or the like may be searched using the partial strings as search keywords, and the search results treated as display data.

Furthermore, an image may be searched using the partitioned partial strings as keywords, and the image obtained may be displayed as image data.

With this kind of composition, for example when the partial strings have “seaweed” “stem” “white wine” and “steaming”, it is possible to display analysis for “seaweed stem” and “white wine steaming”, as well as lumping “seaweed” and “stem” together and lumping “white wine” and “steaming” together.

In addition, with the above-described first through third embodiments, the word string that was the analysis target was a menu, but the present invention can be applied to word strings in arbitrary categories besides menus. The word strings that are the analysis target of the present invention are preferably word strings in categories having the characteristics that words appearing are limited and rules for division methods between words are restricted. Examples of word strings in these kinds of categories besides menus include addresses, statements and explanation of the efficacy of medicines, and/or the like.

In addition, the part that is the core for accomplishing processes for the information processing device comprising the information processor 701, the data memory 702, the program memory 703 and/or the like is not limited to a special system but can be realized using a regular computer system. For example, such a system may be comprised by storing a computer program for executing the above-described operations on a computer-readable memory medium (flexible disk, CD-ROM, DVD-ROM and/or the like) and distributing such, and an information terminal for executing the above processes by installing this computer program on a computer. In addition, the system may be composed by storing the computer program on a memory device possessed by a server device on a communication network such as the Internet and/or the like, and having a normal computer system download such.

In addition, when the functions of the information processing device are allocated between an OS (operating system) and application program and are realized through cooperation between the OS and application program, the application program portion alone may be stored on a recording medium or memory device.

It is also possible to overlay the computer program on carrier waves and distribute such via a communication network. For example, the computer program may be posted on a bulletin board system (BBS) on a communication network, and the computer program may be distributed via the network. Furthermore, the device may be composed so that the above-described process is executed by activating this computer program and executing such similar to other application programs under the control of the OS.

In addition, a portion of the process executed by the above-described information processing device may be realized using a computer independent of the menu display device.

Having described and illustrated the principles of this application by reference to one or more embodiments, it should be apparent that the embodiments may be modified in arrangement and detail without departing from the principles disclosed herein and that it is intended that the application be construed as including all such modifications and variations insofar as they come within the spirit and scope of the subject matter disclosed herein.

What is claimed is:

1. An information processing device, comprising:
a word string acquirer which acquires a word string that is a target of analysis;
a partial string extractor which extracts, using two words on either side of each space in the word string acquired by the word string acquirer, a partial string containing one word but not the other, a partial string not containing the one word but containing the other, and a partial string containing both words from the acquired word string;
a division coefficient acquirer which acquires, for each partial string extracted by the partial string extractor, division coefficients indicating degree of reliability in dividing the partial string by respective division patterns that divide the partial string into words;
a probability coefficient acquirer which calculates a coefficient indicating probability that the word string is divided at the space, based on the division coefficients acquired by the division coefficient acquirer; and
an ouputter which determines division of the word string that is the target of analysis based on the coefficient calculated by the probability coefficient acquirer, and divides and outputs the word string acquired by the word string acquirer.

2. The information processing device according to claim 1, further comprising a coefficient memory which stores division coefficients in accordance with division patterns that divide partial strings comprising multiple words extracted from instructor data containing multiple model sentences;
wherein the division coefficient acquirer acquires division coefficients corresponding to division patterns of the partial string from the coefficient memory.

3. The information processing device according to claim 2, wherein the partial string extractor extracts partial strings in order from a start of the word string that is the target of analysis.

4. The information processing device according to claim 3, wherein the instructor data contains model sentences comprising word strings that belong to a same category as the word string that is the target of analysis.

5. The information processing device according to claim 4, wherein:
the word string acquirer comprises:
a photographer which photographs an image of a character string; and
a character string extractor which extracts a character string from the image photographed by the photographer; and
the outputter comprises:
a converter which converts the divided word string to display data indicating meanings of words contained in the divided word string; and
a display which displays the display data converted by the converter.

6. The information processing device according to claim 1, further comprising an instructor data memory which stores instructor data containing multiple model sentences;
wherein the division coefficient acquirer extracts model sentences containing the partial string from the instructor data memory, and acquires division coefficients based on a number of the extracted model sentences.

7. The information processing device according to claim 6, wherein the partial string extractor extracts partial strings in order from a start of the word string that is the target of analysis.

8. The information processing device according to claim 7, wherein the instructor data contains model sentences comprising word strings that belong to a same category as the word string that is the target of analysis.

9. The information processing device according to claim 8, wherein:
the word string acquirer comprises:
a photographer which photographs an image of a character string; and
a character string extractor which extracts a character string from the image photographed by the photographer; and
the outputter comprises:
a converter which converts the divided word string to display data indicating meanings of words contained in the divided word string; and
a display which displays the display data converted by the converter.

10. An information processing method using a computer and comprising steps of:
acquiring a word string that is the target of analysis;
extracting, using two words on either side of each space in the word string acquired, a partial string containing one word but not the other, a partial string not containing the one word but containing the other, and a partial string containing both words from the acquired word string;
acquiring, for each partial string extracted, division coefficients indicating degree of reliability in dividing the partial string by respective division patterns that divide the partial string into words;
calculating a coefficient indicating probability that the word string is divided at the space, based on the division coefficients acquired; and
determining division of the word string that is the target of analysis based on the coefficient calculated, and dividing and outputting the word string acquired.

11. The information processing method according to claim 10, wherein:
the computer comprises a coefficient memory which stores division coefficients in accordance with division patterns that divide partial strings comprising multiple words extracted from instructor data containing multiple model sentences; and
the division coefficient acquiring step acquires division coefficients corresponding to division patterns of the partial string from the coefficient memory.

12. The information processing method according to claim 11, wherein the partial string extracting step extracts partial strings in order from a start of the word string that is the target of analysis.

13. The information processing method according to claim 12, where the instructor data contains model sentences comprising word strings that belong to a same category as the word string that is the target of analysis.

14. The information processing method according to claim 13, wherein:
the word string acquiring step comprises:
a step of photographing an image of a character string; and
a step of extracting a character string from the image photographed; and
the outputting step comprises:
a step of converting the divided word string to display data indicating meanings of words contained in the divided word string; and
a step of displaying the converted display data.

15. The information processing method according to claim 10, wherein:
the computer comprises an instructor data memory which stores instructor data containing multiple model sentences; and
the division coefficient acquiring step extracts model sentences containing the partial strings from the instructor data memory, and acquires division coefficients based on a number of the extracted model sentences.

16. The information processing method according to claim 15, wherein the partial string extracting step extracts partial strings in order from a start of the word string that is the target of analysis.

17. The information processing method according to claim 16, wherein the instructor data contains model sentences comprising word strings that belong to a same category as the word string that is the target of analysis.

18. The information processing method according to claim 17, wherein:
the word string acquiring step comprises:
a step of photographing an image of a character string; and
a step of extracting a character string from the image photographed; and
the outputting step comprises:
a step of converting the divided word string to display data indicating meanings of words contained in the divided word string; and
a step of displaying the converted display data.
